(19) United States
(12) Patent Application Publication
(10) Pub. No.: US 2004/0013267 A1
(43) Pub. Date: Jan. 22, 2004

(54) Copyright protection system

(76) Inventor: Teruhisa Yokosawa, Nagano (JP)

Correspondence Address: KANESAKA AND TAKEUCHI, 1423 Powhatan Street, Alexandria, VA, 22314, US

(21) Appl. No.: 10/158,202

(22) Filed: May 31, 2002

(30) Foreign Application Priority Data
Jun. 4, 2001 (JP) 2001-168258

(51) Int. Cl. H04N 7/167

(52) U.S. Cl. 380/201; 380/205

(57) ABSTRACT

A copyright protection system includes a digital AV set, a copyright management server, and a financial agency. The digital AV set includes a storage device for storing copyrighted digital AV data coded for protecting the copyright thereof. The digital AV set calls the server and sends data which the digital AV set stores including an account number of the user, a code number of the user, time data and set number to the server. The server communicates with the financial agency and issues a decoding key for decoding the code of the digital AV data in the form of decoding data for decoding the decoding key in exchange for payment of the royalty from the user. The digital AV set decodes the digital AV data using the decoding key produced from the decoding data.

### BACKGROUND OF THE INVENTION AND RELATED ART STATEMENT

The present invention relates to a copyright protection system for protecting the copyright of digital data of various kinds of software, such as music, films, documents and games. Hereinafter, the audio-visible data, such as sound data, voice data, picture data and image data, which are audible or visible, is collectively referred to as the “AV data”.

Specifically, the present invention relates to a copyright protection system, which enables means for reproducing the digital AV data, such as a digital television set and a personal computer (hereinafter referred to as a “digital AV set”), to decode the copyrighted digital AV data when a user wants to see or listen to the copyrighted AV data via the digital AV set. The copyrighted digital AV data is provided with a copyright protection function for preventing illegal reproductions thereof. In other words, the copyrighted digital AV data is coded to protect the copyright thereof. Therefore, the present invention relates to a copyright protection system, which enables the digital AV set to reproduce the copyrighted AV data, when the user, who has received a key for decoding the copyrighted AV data coded from the copyright holder in exchange for paying the royalty, inputs the key to the digital AV set.

When a user wants to display images of a film coded in the form of digital AV data on a digital AV set or output sounds of music coded in the form of digital AV data from a digital AV set, the user purchases a storage medium, such as a DVD and a CD, storing the digital AV data or downloads the digital AV data to the digital AV set via the internet. When the user purchases a storage medium, such as a DVD and a CD, storing the digital AV data or downloads the digital AV data to the digital AV set via the internet, the user pays a fee including the royalty to enable the user to use the digital AV data.

Usually, the above described storage medium is provided with a copyright protection function to prevent the data stored in the medium from being copied illegally. However, since some programs for disabling the copyright protection function are distributed, the copyright protection function is disabled repeatedly. Therefore, it is very difficult to completely protect the copyright.

Since the digital AV data, once down loaded, is not provided with any copyright protection function, the down loaded digital AV data is copied easily. Therefore, how to protect the copyright is very serious problems under the present situation, under which more and more AV data has been stored in the digital form and the distributions of the digital AV data via digital broadcasting or via the internet have started already.

In view of the foregoing, it is an object of the invention to provide a copyright protection system, which facilitates protecting the copyright of digital AV data, convenient use of the digital AV data by the users, and paying the royalty exactly for the actual use of the digital AV data by the users so as not to cause any demerit against the users.

Further objects and advantages of the invention will be apparent from the following description of the invention.

### SUMMARY OF THE INVENTION

According to the invention, there is provided a copyright protection system including: a digital AV set including a storage device for storing digital AV data including AV data and copyright number of the AV data, the digital AV data being coded to protect the copyright of the AV data, and an AV data decoder for decoding the coded AV data using a decoding key for decoding the coded AV data; a financial agency having an account and a code number registered therein of the user, to which the royalty is charged, the account number and the code number of the user being set in the digital AV set; a copyright management server communicating between the digital AV set and the financial agency. The copyright management server issues the decoding key in response to the request from the digital AV set requesting issuance of the decoding key and in exchange for collection of the royalty of the digital AV data.

The digital AV set sends the copyright number, the account number and the code number to the copyright management server in advance to reproducing the AV data to request the copyright management server to issue the decoding key. The copyright management server receives the sent copyright number, account number and code number, and collects the royalty from the financial agency based on the received copyright number, account number and code number. Then, the decoding key is issued to the digital AV set.

Advantageously, the digital AV data coded for protecting the copyright thereof includes a preamble section containing digital AV data not coded and a main section containing the digital AV data coded for protecting the copyright thereof. The preamble section contains predetermined access data necessary to access to the copyright management server.

Advantageously, the coded digital AV data of the main section is divided into a plurality of subsections coded for protecting the respective copyrights thereof, and the coded subsections are decoded with the respective decoding keys. Also, the copyright management server issues to the digital AV set decoding key data formed of the decoding key and the predetermined data sent to the copyright management server from the digital AV set requesting the copyright management server to issue the decoding key.

Advantageously, the predetermined data contains a set number identifying the digital AV set and time data indicating the date and the time, at which the issuance of the decoding key is requested.

The copyright protection system according to the invention functions in the following manner. First, copyrighted digital AV data coded for protecting the copyright thereof is distributed without restricting the copying thereof. If copied, the coded digital AV data can not be used (seen or listened to) in practice as far as it is not decoded, since the copyrighted digital AV data is coded to protect the copyright thereof.

When the user wants to reproduce the digital AV data, the copyright protection system according to the invention communicates on the real time basis between the digital AV set for reproducing the digital AV data and the copyright management server on the side of the copyright holder, and between the copyright management server and the financial agency, such as a bank and a credit company. In the financial agency, the account of the user of the digital AV data, to which the royalty is charged, is registered. The copyright protection system pays the royalty from the account of the user, to which the royalty is charged, to the copyright management server on the copyright holder side, and requests the copyright management server to issue a decoding key for decoding the copyrighted digital AV data coded.

The digital AV set decodes the copyrighted digital AV data coded using the decoding key and reproduces the AV data.

### BRIEF DESCRIPTION OF THE DRAWINGS

FIG. 1 is a block diagram showing the system configuration of a copyright protection system according to an embodiment of the invention.

### DETAILED DESCRIPTION OF PREFERRED EMBODIMENTS

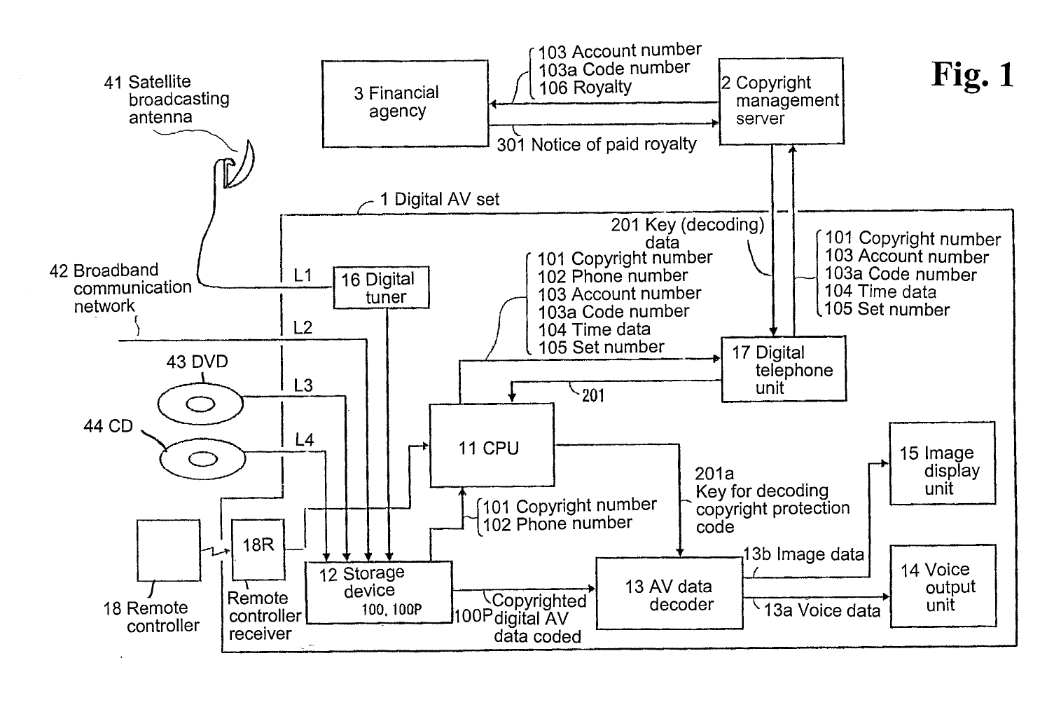

FIG. 1 is a block diagram of a copyright protection system according to an embodiment of the invention. Referring now to FIG. 1, digital AV data 100 not copyrighted and digital AV data 100P copyrighted are inputted to a digital AV set 1, such as a personal computer and a digital television set. The digital AV set 1 receives a key 201a for decoding the copyrighted digital AV data coded 100P from a copyright management server 2 described later on the side of the copyright holder. The digital AV set 1 decodes the coded digital AV data 100P and reproduces the digital AV data 100 and 100P.

A set number 105 for identifying the digital AV set 1 is inputted to the digital AV set 1 and set therein. The set number 105 is used as described later to prevent the key 201a from being copied illegally. Date data and time data for correction are initially set in the digital AV set 1 via a remote controller 18 to automatically indicate the present date and time. Hereinafter, the date data and the time data are referred to collectively as the “time data”.

The bank account number and the credit card number (hereinafter, the numbers identifying the account for paying the royalty will be referred to collectively as the “account number 103”) of the user who uses the digital AV set 1 (that is the user of the copyrighted digital AV data 100P) and the code number 103a of the user are also set initially in the digital AV set 1 via the remote controller 18.

In FIG. 1, the account of the user who pays the royalty, usually the user of the digital AV data 100P, is registered in a financial agency 3, such as a bank and a credit company. The copyright management server 2 is a data processing unit for managing the copyrights of the copyright holders, such as companies or persons, holding the copyrights of the copyrighted digital AV data 100P.

The copyright management server 2 communicates with the digital AV set 1 and financial agency 3. The copyright management server 2 does not issue the key 201a for decoding the copyright protection code but issues key (decoding) data 201 for producing the key 201a on the real time basis in exchange for the collection of the royalty 106 to prevent the key 201a for decoding the copyright protection code from being looked surreptitiously. The royalty 106 may contain an additional charge.

The digital AV set 1 includes a CPU 11, which controls the entire digital AV set 1; a storage device 12, such as a magnetic disk storage, which stores digital AV data 100 and 100P; and data input lines L1 through L4 for inputting the digital AV data 100 and 100P to the storage device 12.

The digital AV data 100 and 100P sent via satellite broadcasting are inputted to the storage device 12 via a satellite broadcasting antenna 41, the data input line L1 and a digital tuner 16 in the digital AV set 1. The digital AV data 100 and 100P acquired via the internet, a cable television and such a broadband communication network are inputted to the storage device 12 via the data input line L2 connected to any of the broadband communication networks. The digital AV data 100 and 100P stored in a digital video disk (DVD) 43 are inputted to the storage device 12 via a not shown DVD drive and the data input line L3. The digital AV data 100 and 100P stored in a compact disk (CD) 44 are inputted to the storage device 12 via a not shown CD drive and the data input line L4.

The copyrighted digital AV data 100P coded will not be reproduced, if the copyrighted digital AV data 100P is not decoded by the key 201a issued from the copyright holder. In this embodiment, the copyrighted digital AV data 100P is compressed data.

The digital AV set 1 includes an AV data decoder 13, which decodes the copyright protection code of the copyrighted digital AV data 100P using the key 201a. The digital AV set 1 includes a voice output unit 14 which outputs voice data 13a, the copyright protection code thereof being decoded in the AV data decoder 13 in the form of audible voices and sounds. The digital AV set 1 includes an image display unit 15 which outputs image data 13b, the copyright protection code thereof being decoded in the AV data decoder 13 in the form of visible pictures and images. The digital AV set 1 also includes a digital telephone unit 17, which exhibits the similar functions as those of the mobile telephone. The digital telephone unit 17 communicates with the copyright management server 2 by wireless, e.g. in the i mode, under the control of the CPU 11.

In FIG. 1, a remote controller 18 is shown. The remote controller 18 is means for inputting various kinds of data and commands to the digital AV set 1 by wireless in response to the key operations by the user. The digital AV set 1 includes a remote controller receiver 18R, which receives signals from the remote controller 18 and transmits the received signals to the CPU 11.

Now, the operation of the system shown in FIG. 1 will be described below in connection with a case, in which the digital AV data 100P is image data. The digital AV data 100P is formed of a not coded preamble section, that is an introductory section, not copyrighted, and a coded main section copyrighted. The coded main section copyrighted may be divided into several subsections. The preamble section of the digital AV data 100P contains the data indicating the royalty, and the data indicating the copyright number 101 and the phone number 102 of the copyright management server 2 necessary to access to the copyright management server 2, which issues the key 201a for decoding the copyright protection code.

At first, the user selects the digital AV data 100 or 100P stored in the storage device 12 and containing the picture data, which the user wants to see. When the copyrighted digital AV data 100P coded is selected, the image of the preamble section of the copyrighted digital AV data 100P coded is displayed, at first, on the image display unit 15.

In detail, the royalty 106, the copyright number 101, and the phone number 102 of the copyright management server 2 are displayed. If necessary for confirming the user, a picture or display for requesting the user to input the data necessary for paying the royalty, such as the account number 103 and the code number 103a of the user, which are necessary to issue the key 201a for decoding the copyright protection code, is also displayed.

After the user, who has inputted the necessary items via the remote controller 18, presses the enter key, the image of the preamble section is displayed again on the display unit 15. Then, the image of the main section of the copyrighted digital AV data 100P coded is displayed, after the payment of the royalty 103 on real time as described later finishes.

While the image of the main section of the copyrighted digital AV data 100P coded is being displayed, the CPU 11 sends the copyright number 101 and the phone number 102 of the copyright management server 2 reads out from the digital AV data 100P to the digital telephone unit 17, together with the account number 103, the code number 103a and the set number 105, inputted to the digital AV set 1, and the time data 104 including the present time, which the digital AV set 1 indicates.

The digital telephone unit 17 dials the phone number 102 to call the copyright management server 2 and requests the copyright management server 2 to issue the key 201a for decoding the copyright protection code in exchange for sending the copyright number 101, the account number 103, the code number 103a, the time data 104, and the set number 105. In response to this call, the copyright management server 2 collects the royalty based on the notified copyright number 101. In detail, the copyright management server 2 notifies the financial agency 3 of the royalty 106, that is the charge to be paid, as well as the account number 103 and the code number 103a, which the copyright management server 2 has received from the digital AV set 1.

As soon as the copyright management server 2 receives a notice of paid royalty 301 notifying from the copyright management server 2 of the payment of the royalty 106 to the copyright holder from the financial agency 3, the copyright management server 2 produces decoding data 201 formed of the time data 104, the set number 105 and the actual key 201a for decoding the copyright protection code and sends the decoding data 201 to the digital AV set 1. The digital AV set 1 produces the practical key 201a for decoding the copyright protection code based on the decoding data 201, which the digital AV set 1 has received, the time data 104 and the set number 105, which the digital AV set 1 sent to the copyright management server 2.

Even if one kind of decoding key 201a is produced, the decoding data 201, which can be looked from outside, will change every time depending on the set number 105 of the digital AV set 1, which uses the decoding data 201, and the date of using the digital AV set 1, that is the time data 104. Therefore, even if the decoding key 201a is intercepted by other digital AV set 1, the decoding key 201a is prevented from being used illegally by the other digital AV set 1. Thus, it is possible to protect the copyright securely.

Since the main section of the digital AV data 100P coded to protect the copyright is decoded in the AV data decoder 13 with the decoding key 201a at the stage of displaying the main section of the digital AV data 100P, actual images become visible.

When the copyright management server 2 is notified from the financial agency 3 that the financial agency 3 has failed to charge the royalty 106, the copyright management server 2 does not send the decoding data 201 but sends to the digital AV set 1 the notice notifying that the royalty 106 has failed to be paid. In response to this, the digital AV set 1 stops displaying as soon as the image display of the preamble section finishes.

When the main section of the copyrighted digital AV data 100P coded is divided into subsections, the divided subsections are provided with respective copyright numbers 101. When the undivided main section of the copyrighted digital AV data 100P coded is provided with one single copyright number 101, the divided subsections are provided with respective sub-numbers. In these cases, the copyright management server 2 provides all the subsections to have the respective copyright numbers 101 or the respective sub-numbers with decoding keys 201a.

While displaying the image of one main subsection, the digital AV set 1 acquires the decoding key 201a for the main subsection to be displayed next. Alternatively, the digital AV set 1 displays the image of the not-copyrighted digital AV data between the main subsections of the copyrighted digital AV data for a time period, for which the digital AV set 1 acquires the decoding key 201a for the main subsection to be displayed next. These schemes facilitate displaying the images of the AV data without causing any interruption and, therefore, making the user enjoy the film or the music without causing any incongruous feeling.

When the user, now tired of the contents of the digital AV data, presses the interruption key, the royalty is charged corresponding to what the user has really watched or listened to. In other words, the royalty is charged corresponding to the contents of the AV data, which the user has used. As described above, the copyright is protected more securely by dividing the copyrighted digital AV data coded into subsections and by providing the subsections with respective decoding keys 201a.

The following scheme is employable to allow the user to see the film televised on digital broadcasting once for free. The digital AV data of the free film contains the bank account number and the code number of the broadcasting station embedded in the preamble section thereof. The digital AV set 1 sends the bank account number and the code number of the broadcasting station to the copyright management server 2 for the account number 103 and the code number 103a thereof.

As described above, the digital AV set 1 acquires the decoding data 201 including the decoding key 201a from the copyright management server 2 and allows the user to see the film once for the payment from the broadcasting station, that is for free. The bank account number and the code number of the broadcasting station may not be abused, if they are assigned solely to the specific film and set for a limited period of time.

When the user sees the digital AV data of the film digitally copied in advance after the free period is expired, the royalty will be charged, since the data sent from the digital AV set 1 to the copyright management server 2 for requesting the decoding key 201a contains the time data 104.

The copyright protection system according to the invention facilitates obtaining or copying the copyrighted digital AV data coded such as pictures, music and documents freely without paying the royalty. The copyright protection system according to the invention, then, facilitates acquiring a decoding key for decoding the copyright protection code on the real time bases for the royalty at the instance when the digital AV data is actually reproduced.

The copyright protection system according to the invention, which exhibits the functions described above facilitates protecting the copyright securely. It is easy for the users to use the copyright protection system according to the invention. The copyright protection system according to the invention enables the users to select the digital AV data which they really want to use and to pay the royalty for the digital AV data which they really used.

While the invention has been explained with reference to the specific embodiments of the invention, the explanation is illustrative and the invention is limited only by the appended claims.

What is claimed is:

1. A copyright protection system comprising:
a digital AV set for a user including a storage device for storing coded digital AV data and a copyright number of the AV data to protect copyright of the AV data, and an AV data decoder for decoding the coded AV data using a decoding key for decoding the coded AV data;
a financial agency having an account and a code number registered therein for the user, to which a royalty is charged, said account number and code number for the user being set in the digital AV set; and
a copyright management server communicating between the digital AV set and the financial agency, the copyright management server issuing the decoding key in response to a request from the digital AV set requesting issuance of the decoding key and in exchange for collection of the royalty of the digital AV data;
wherein the digital AV set sends the copyright number, the account number and the code number to the copyright management server in advance to reproduce the AV data, to request the copyright management server to issue the decoding key; and the copyright management server collects the royalty from the financial agency based on the received copyright number, account number and code number, and then issues the decoding key to the digital AV set.

2. A copyright protection system according to claim 1, wherein said digital AV data coded for protecting the copyright thereof comprises a preamble section having digital AV data not coded, and a main section having the digital AV data coded for protecting copyright thereof, said preamble section containing predetermined access data necessary to access to the copyright management server.

3. A copyright protection system according to claim 2, wherein said coded digital AV data of the main section is divided into a plurality of subsections coded for protecting respective copyrights, and the coded subsections are decoded with respective decoding keys.

4. A copyright protection system according to claim 1, wherein said copyright management server issues to the digital AV set decoding key data having the decoding key and predetermined data sent to the copyright management server from the digital AV set requesting the copyright management server to issue the decoding key.

5. A copyright protection system according to claim 4, wherein said predetermined data comprises a se t number identifying the digital AV set and time data indicating the date and time, at which the issuance of the decoding key is requested.
